(19) United States
(12) Patent Application Publication
(10) Pub. No.: US 2013/0314196 A1
(43) Pub. Date: Nov. 28, 2013

(54) Wound Core Scot Transformer

(71) Applicant: HITACHI INDUSTRIAL EQUIPMENT SYSTEMS CO., LTD., Tokyo (JP)

(72) Inventors: Tatsuhito AZEGAMI, Shibata (JP); Masaki TAKEUCHI, Tainai (JP); Kohei SATO, Tainai (JP); Atsushi SUZUKI, Tainai (JP); Yoshimitsu ITO, Shibata (JP); Hisashi KOYAMA, Tainai (JP)

(73) Assignee: HITACHI INDUSTRIAL EQUIPMENT SYSTEMS CO., LTD., Tokyo (JP)

(21) Appl. No.: 13/772,829

(22) Filed: Feb. 21, 2013

(30) Foreign Application Priority Data
May 25, 2012 (JP) 2012-119179

(51) Int. Cl. H01F 27/25

(52) U.S. Cl. CPC H01F 27/25
USPC 336/213

(57) ABSTRACT

A wounded core Scott transformer configured so that opposed core legs of wounded cores corresponding to core legs mounted in a main coil and a teaser coil are arranged on the inside between the respective coils so as to be supported.

### INCORPORATION BY REFERENCE

The present application claims priority from Japanese patent application JP2012-119179 filed on May 25, 2012, the contents of which are hereby incorporated by reference into this application.

### BACKGROUND OF THE INVENTION

The present invention relates to a wound core Scott transformer for power receiving and distribution or the like.

As background arts in the present technical field, there are JP-A-2-272710 (Patent Literature 1) and JP-A-2001-60522 (Patent Literature 2).

As disclosed in Patent Literature 1, a Scott transformer for power receiving and distribution has a structure composed of a main coil and a teaser coil, each of which has a core leg. The Scott transformer includes the two coils as well as three or more core legs, and therefore no coil is arranged with respect to some of the core legs.

In Patent Literature 2, a structure of a wound core transformer has been described. The wound core is formed of a plurality of laminated strips of a core material into a generally rectangular shape such that its one side has a seam part. Then, core legs are mounted in coils to join and bind the seam part so that deformation of the wound core is prevented.

### SUMMARY OF THE INVENTION

In the conventional Scott transformer, a core is self-supported by a laminated core structure whose lamination direction is different from a wound core structure. The Scott transformer disclosed in Patent Literature 1 is on the assumption of shape retention owing to self-supporting of a core leg. However, if self-supporting of a core is relatively difficult because the core material strip is thinned, for example, when amorphous alloy strip or the like is used, the shape of the wound core structure needs to be supported or retained.

Some idea is needed to provide means for supporting and retaining the shape of such a wound core structure.

An object of the present invention is to implement such idea to provide a wound core Scott transformer having high reliability and superior cost performance.

According to an embodiment of the present invention of the present application to achieve the above described object, there is provided a wound core Scott transformer in which another-side core legs opposite to core legs mounted in a main coil and a teaser coil are arranged on the inside between the respective coils, and a cylindrical body, for example, a resin bobbin is mounted on the inside core legs for the purpose of preventing deformation of the inside core legs.

Other embodiments of the present invention to achieve the above described object will be described below.

There is provided a wound core Scott transformer including a main wound core and a teaser wound core which are made by winding thin strips of a core material, wherein a main coil or a teaser coil is mounted to the wound cores, wherein the main wound core includes a main coil mounting core leg on which the main coil is mounted, and a main coil non-mounting core leg on which the main coil is not mounted, the teaser wound core includes a teaser coil mounting core leg on which the teaser coil is mounted, and a teaser coil non-mounting core leg on which the teaser coil is not mounted, and the main coil non-mounting core leg and the teaser coil non-mounting core leg are positioned in proximity to each other, and are supported by a cylindrical body into which the main coil non-mounting core leg and the teaser coil non-mounting core leg are inserted.

Further, the cylindrical body may include a non-conductive material.

Further, the cylindrical body may be made of a non-conductive material in a cylindrical shape which is wound with an insulator of a glass base material, the outside of which is wound with a non-conductive material.

Further, the non-conductive material may be an insulating film.

Further, the main coil non-mounting core leg and the teaser coil non-mounting core leg may be positioned in proximity to each other, a supporting member that supports the main coil non-mounting core leg may be provided on the inside of the main wound core, and a supporting member that supports the teaser coil non-mounting core leg may be provided on the inside of the teaser wound core.

Further, the supporting member may be formed in a plate-like shape.

By implementing the present invention, a Scott transformer having a wound core that uses a core material strip which is difficult to be self-supporting can be fabricated, so that the wound core Scott transformer having high reliability and superior cost performance can be provided.

Other objects, features and advantages of the invention will become apparent from the following description of the embodiments of the invention taken in conjunction with the accompanying drawings.

### BRIEF DESCRIPTION OF THE DRAWINGS

FIGS. 1A, 1B, and 1C are, respectively, a front view, a side view, and a plan view of a wound core Scott transformer according to an embodiment of the present invention;

FIGS. 2A, 2B, and 2C are, respectively, a front view, a side view, and a plan view of a wound core Scott transformer according to another embodiment of the present invention; and

FIG. 3 is an example configuration diagram of a resin bobbin according to another embodiment of the present invention (a cross-sectional view of section A in FIG. 1A).

### DESCRIPTION OF THE EMBODIMENTS

Hereinafter, embodiments will be described with reference to the drawings.

### Embodiment 1

In the present embodiment, a configuration of a wound core Scott transformer will be described.

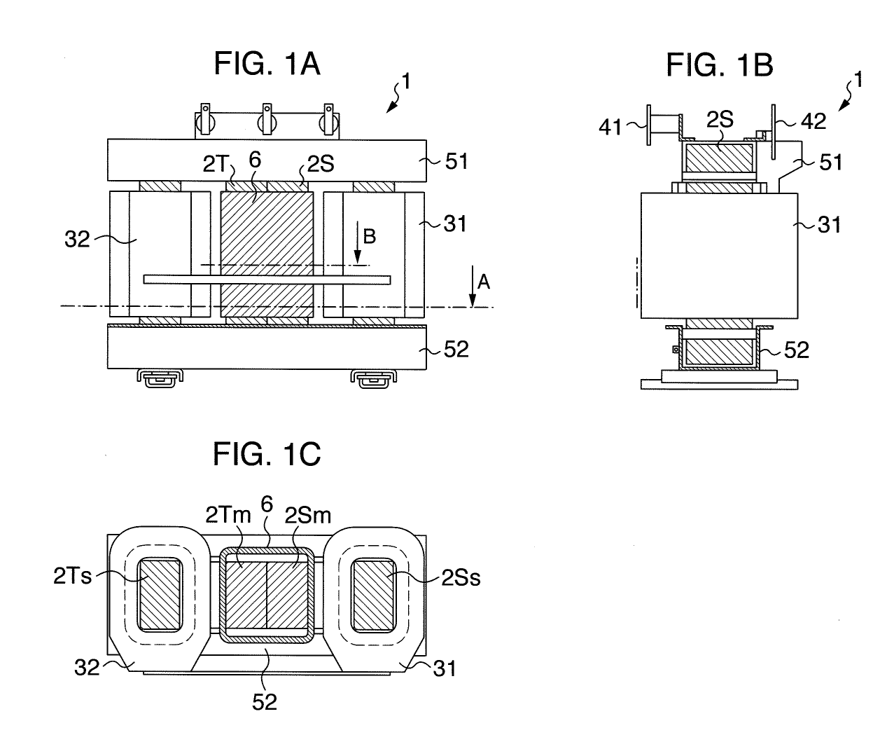

FIGS. 1A, 1B, and 1C are, respectively, a front view, a side view, and a plan view of the wound core Scott transformer of the present embodiment.

The wound core Scott transformer 1 for power receiving and distribution includes a main core 2S, a teaser core 2T, a main coil 31, a teaser coil 32, a first terminal 41, a second terminal 42, an upper metal fitting 51, and a lower metal fitting 52.

The main coil 31 is mounted to the main core 2S, and the teaser coil 32 is mounted to the teaser core 2T.

As shown in the plan view of FIG. 1C, a core leg of the main core 2S on which the main coil 31 is mounted is referred to as a main coil mounting core leg 2Ss, and a core leg of the main core 2S on which the main coil 31 is not mounted is referred to as a main coil non-mounting core leg 2Sm.

Further, a core leg of the teaser core 2T on which the teaser coil 32 is mounted is referred to as a teaser coil mounting core leg 2Ts, and a core leg of the teaser core 2T on which the teaser coil 32 is not mounted is referred to as a teaser coil non-mounting core leg 2Tm.

By the way, in a case where a core material strip, for example, an amorphous alloy strip is used which has low rigidity and is difficult to be self-supporting, the cores 2T, 2S may be configured to have a wound core structure.

If the main core 2S and teaser core 2T have the wound core structure, the main coil non-mounting core leg 2Sm and the teaser coil non-mounting core leg 2Tm, which are legs on which no coil is mounted, may be deformed by their own weight. Alternatively, it is assumed that shoulders of the main coil non-mounting core leg 2Sm and the teaser coil non-mounting core leg 2Tm of the main core 2S and teaser core 2T may be lowered by their own weight.

In order to prevent deformation of inside core legs on which no coil is mounted (the main coil non-mounting core leg 2Sm and the teaser coil non-mounting core leg 2Tm), a cylindrical member, for example, a resin bobbin is arranged, so that deformation of the cores is prevented.

As shown in the front view and the side view in FIG. 1(A) and FIG. 1(B), as with the coils, the position of the resin bobbin is fixed by tightening of the upper metal fitting 51 and the lower metal fitting 52. Since the resin bobbin is a non-conductive material here, even if the bobbin is arranged in a place closer than the core, insulation performance and separation distance are not affected.

For example, if the shape of an inside core leg on which no coil is mounted is retained using a bobbin whose material is metal, or the core is covered with a metal cover, the cover may be arranged in a place closer to a coil adjacent to the core.

In this case, it is expected that the electric insulation performance is lowered, or measures are required to increase the size and mass of the transformer so as to keep a required separation distance.

In contrast, if core deformation is prevented using the resin bobbin 6 as in the above described present embodiment, no special measures are required about electric insulation performance.

As described above, in the present embodiment, deformation of the cores can be reduced and prevented by a cylindrical member which prevents deformation of the inside core legs (the main coil non-mounting core leg 2Sm and the teaser coil non-mounting core leg 2Tm). Furthermore, the cylindrical member is non-conductive material as well as an insulating member so that measures are taken against degradation of insulation performance with the cylindrical member. Therefore, consideration given to the performance of the insulation between the cylindrical member and the live part and the like including the main core 2S, the teaser core 2T, the main coil 31, the teaser coil 32, the first terminal 41, the second terminal 42, the upper metal fitting 51, the lower metal fitting 52 and the like can be reduced, and measures to keep insulating characteristics and measures to provide a separation distance can be reduced. As a result, size reduction, weight reduction and the like of the wounded core Scott transformer can be achieved compared to conventional wounded core Scott transformers.

### Embodiment 2

In the present embodiment, a method of preventing deformation of a wounded core by a plate-like member will be described.

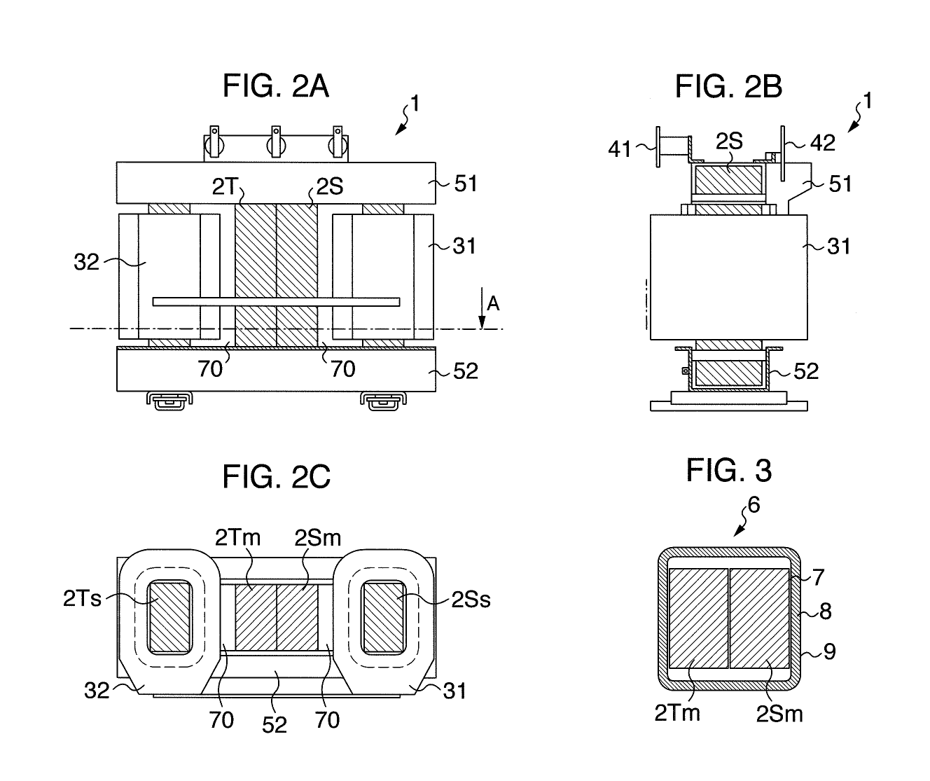

FIGS. 2A to 2C are configuration diagrams of a wounded core Scott transformer of the present embodiment. Within the wounded core Scott transformer configuration diagrams of FIGS. 2A to 2C, description of parts having functions identical to the previously described components with the same reference characters are omitted.

In the embodiment 1, an example is illustrated in which the shapes of the inside core legs on which no coil is mounted (the main coil non-mounting core leg 2Sm and the teaser coil non-mounting core leg 2Tm) are retained using the resin bobbin that is a cylindrical member.

In the embodiment of FIGS. 2A to 2C, the shapes of inside core legs on which no coil is mounted (the main coil non-mounting core leg 2Sm and the teaser coil non-mounting core leg 2Tm) are supported by a supporting member formed in a plate-like shape instead of a resin bobbin.

As shown in the front view and the plan view of FIG. 2A and FIG. 2C, plate-like supporting members 70 are arranged on inside circumferences or sides of the main coil mounting core leg 2Ss and the teaser coil mounting core leg 2Ts to support and retain the cores so as to prevent deformation of the cores.

As shown in FIG. 2A to 2C, another-side core legs on which no coil is mounted (the main coil non-mounting core leg 2Sm and the teaser coil non-mounting core leg 2Tm) are arranged on the inside between the main coil 31 and the teaser coil 32, so that the size and the mass can be reduced in this structure compared to a structure in which these legs are arranged on the outside of the respective cores. Therefore, it is expected that the Scott transformer having superior cost performance can be provided.

The material of the plate-like supporting member 70 just need to be able to support and retain the cores so as to prevent deformation of the cores, and may be a resin, a wood, a metal, or the like.

However, if the metal is used, measures may need to be taken so as not to lower the electric insulation performance due to arrangement of the supporting member in a place closer to a coil adjacent to the core, or care may need to be taken to take measures to keep a required separation distance.

### Embodiment 3

In the present embodiment, one example of a manufacturing method of a resin bobbin will be described.

FIG. 3 shows a cross sectional view of section A in FIG. 1A, and is a configuration diagram of a resin bobbin of the present embodiment.

In the manufacturing method of the resin bobbin 6 molded from resin, a former is arranged along the inner circumference, and an inner circumferential insulating film 7 is wound around the former so that it is arranged at the most inner circumference of the bobbin. For example, a polyester material may be used as the inner circumferential insulating film. In order to obtain the thickness of the bobbin, a glass base material layer 8, for example, including a plurality of glass base material insulators is provided on the inner circumferential insulating film, and then an outer circumferential insulating film is wound thereon at the most outer circumference. For example, a polyester material may be used as the outer circumferential insulating film. Resin is cast in these layers of insulators and hardened to form the resin bobbin 6.

The embodiments of the present invention have been described above. Operations and the like of the embodiments will be described below.

The cylindrical member or the plate-like member are provided as a supporting member as previously described, so that deformation of the wounded cores can be reduced and mitigated compared to conventional ways.

When these members are made of a non-conductive material, a non-conductive member, an insulating material, or an insulating member, there is an advantage that insulating characteristics with respect to current-carrying and live parts constituting a transformer and favorable characteristics of separation distance can be improved.

Further, in such a configuration, in addition to prevention and reduction of the wounded cores, silencing of the cores and transformer can be expected.

This is because the support member provided to the wounded cores is allowed to absorb, silence, or reduce a sound, a vibration and the like generated from the wounded cores, the transformer, and the like.

The above described deformation of a wounded core includes that, when the wounded core is self-supported, it bends in a vertical direction by gravity, its corners and shoulders does not form a rectangular shape, and the shape of the wounded core droops. Conventionally, an operation that opens a wrap of the main core 2S of the wounded cores, puts in the main coil 31 and closes the wrap again, and an operation that opens a wrap of the teaser core 2T of the wounded cores, puts in the teaser coil 32 and closes the wrap again are conducted in separated steps. After that, the both wounded cores are combined. Accordingly, these operations can be complicated. On the other hand, in the above described embodiments, a wrap of the main core 2S and a wrap of the teaser core 2T are opened, and the main coil 31 is mounted on the main coil mounting core leg 2Ss and the teaser coil 32 is mounted on the teaser coil mounting core leg 2Ts, and furthermore, in order to prevent deformation of inside core legs on which no coil is mounted (the main coil non-mounting core leg 2Sm and the teaser coil non-mounting core leg 2Tm), the wrap is closed after a supporting member or a cylindrical member, for example, a resin bobbin is arranged on the inside core legs. In this way, according to the above described embodiments, since core legs on which no coil is mounted are positioned on the inside and in proximity to each other, an operation that closes a wrap can be performed after putting coils and a supporting member in core legs, and mounting and arranging them. In consideration of efficiency of wrapping operations for wounded cores, the operations can be improved, and a method and a structure for enhancing productivity can be provided.

Further, the supporting member may have sound absorption capability, silencing capability, sound isolation capability, and the like, and further have heat resistance in consideration of heating during operation, in addition to being made of a non-conductive material, a non-conductive member, an insulating material, or an insulating member as previously described. For heat resistance, the supporting member may be a member including a heat-resistant fiber or a glass fiber.

It should be further understood by those skilled in the art that although the foregoing description has been made on embodiments of the invention, the invention is not limited thereto and various changes and modifications may be made without departing from the spirit of the invention and the scope of the appended claims.

1. A wound core Scott transformer comprising a main wound core and a teaser wound core which are made by winding thin strips of a core material, wherein a main coil or a teaser coil is mounted on the wound cores, wherein
the main wound core includes a main coil mounting core leg on which the main coil is mounted, and a main coil non-mounting core leg on which the main coil is not mounted,
the teaser wound core includes a teaser coil mounting core leg on which the teaser coil is mounted, and a teaser coil non-mounting core leg on which the teaser coil is not mounted, and
the main coil non-mounting core leg and the teaser coil non-mounting core leg are positioned in proximity to each other, and are supported by a cylindrical body into which the main coil non-mounting core leg and the teaser coil non-mounting core leg are inserted.

2. The wound core Scott transformer according to claim 1, wherein the cylindrical body includes a non-conductive material.

3. The wound core Scott transformer according to claim 1, wherein the cylindrical body is made of a non-conductive material in a cylindrical shape which is wound with an insulator of a glass base material, an outside of which is wound with a non-conductive material.

4. The wound core Scott transformer according to claim 2, wherein the non-conductive material is an insulating film.

5. The wound core Scott transformer according to claim 3, wherein the non-conductive material is an insulating film.

6. A wound core Scott transformer comprising a main wound core and a teaser wound core which are made by winding thin strips of a core material, wherein a main coil or a teaser coil is mounted on the wound cores, wherein
the main wound core includes a main coil mounting core leg on which the main coil is mounted, and a main coil non-mounting core leg on which the main coil is not mounted,
the teaser wound core includes a teaser coil mounting core leg on which the teaser coil is mounted, and a teaser coil non-mounting core leg on which the teaser coil is not mounted,
the main coil non-mounting core leg and the teaser coil non-mounting core leg are positioned in proximity to each other,
a supporting member that supports the main coil non-mounting core leg is provided on an inside of the main wound core, and
a supporting member that supports the teaser coil non-mounting core leg is provided on an inside of the teaser wound core.

7. The wound core Scott transformer according to claim 6, wherein the supporting member is formed in a plate-like shape.
